(19) United States
(12) Patent Application Publication
(10) Pub. No.: US 2026/0171773 A1
(43) Pub. Date: Jun. 18, 2026

(54) COUPLING ASSEMBLY AND METHOD FOR JOINING CONDUIT SECTIONS

(71) Applicant: S-P Products, Inc., Elk Grove Village, IL (US)

(72) Inventor: Mikel Bishka, Wheaton, IL (US)

(21) Appl. No.: 19/420,027

(22) Filed: Dec. 15, 2025

Related U.S. Application Data
(60) Provisional application No. 63/734,910, filed on Dec. 17, 2024.

(51) Int. Cl. H02G 3/04; H02G 3/06

(52) U.S. Cl. CPC H02G 3/0481; H02G 3/06

(57) ABSTRACT

A conduit coupling assembly facilitates joining and assembly of conduits, tubing, and like components in a building or other structure, and more particularly to a conduit coupling assembly for conduit sections of differing configurations, including jacketed conduit, galvanized rigid conduit, and electrical metallic conduit (EMT). A method of efficiently joining a jacketed conduit section with an associated conduit section includes use of the present unitary conduit coupling assembly, and respectively joining first and second connectors of the conduit coupling assembly to the jacketed conduit, and to the associated conduit section to thereby connect the jacketed conduit to the conduit section. By this arrangement, associated wiring can be efficiently housed within the jacketed conduit section, the conduit section, and the conduit coupling assembly.

### CROSS-REFERENCE TO RELATED APPLICATIONS

This application claims priority of Provisional Application Ser. No. 63/734,910 filed Dec. 17,2024, the disclosure of which is hereby incorporated by reference.

### FIELD OF THE INVENTION

The present invention relates generally to assembly of conduits, tubing, and like components in a building or other structure, and more particularly to a conduit coupling assembly which facilitates joining conduit sections of differing configurations, including jacketed galvanized rigid conduit, and electrical metallic tubing conduit (EMT).

### BACKGROUND OF THE INVENTION

Electrical conduit and related accessories may be made from a variety of materials such as poly vinyl chloride (PVC), thin wall metal, heavy wall metal, flexible tubing (MC cable and other types of flexible cable), as well as other materials known to those skilled in the art. For some applications, composite or jacketed conduit assemblies, such as comprising a metallic core and a polymeric protective coating, are required. Often-times, these materials are used in combination and therefore, adapters and couplings must be used to join the materials. Couplings are generally used to connect tubing, such as electrical conduit, to various other forms of electrical tubing and support structures.

In the course of a typical installation, it may be necessary for electrical workers to install conduit components which differ in configuration. Bearing in mind that electrical wiring positioned within the conduit components must be threaded and directed through the various components, it is desirable to provide an arrangement which facilitates assembly of the components, while promoting efficient routing of the associated wiring.

### SUMMARY OF THE INVENTION

The present invention is directed to conduit coupling assembly which facilitates assembly of conduit sections, and associated tubular structures, with the conduit components typically used in conjunction with electrical wiring. In the illustrated embodiments, the present coupling assembly facilitates assembly of the coupling assembly with an associated jacketed conduit by the provision of a first, liquid tight connector, and by the provision of a second connector configured for connection to another associated conduit section. This second connector may be configured as: (a) a rigid coupling; (b) an electrical metallic tubing (EMT) compression coupling; and (c) an electrical metallic tubing compression coupling.

Notably, the present coupling assembly can further include a cylindrical adapter nipple having an internal diameter. The adapter nipple has an external thread formation for threaded connection to each of the first and second connectors at internal diameters thereof. By this arrangement, associated wiring can be housed within the conduit coupling assembly, with the wiring extending though the internal diameters of each of the first and second connectors and the adapter nipple. Depending upon the specific configuration of the first and second connectors, the external thread formation of the adapter nipple can include two differing thread patterns for respective threaded connection to the first and second connectors of the coupling assembly.

In the preferred embodiment of the invention, the coupling assembly includes an adhesive composition applied to the external thread formation of the adapter nipple for securement of the adapter nipple to the first and second connectors of the assembly.

For some applications, the adapter nipple is not required, with an external thread formation provided on the first, liquid tight connector for threaded engagement directly with an internal thread formation provided on the second connector of the conduit coupling assembly. A suitable adhesive is preferably applied to the mating threaded components of the coupling assembly.

In accordance with the present invention, a method of connecting a jacketed conduit to an associated conduit section comprises the steps of providing the jacketed conduit, and the associated conduit section. The present method further entails providing a unitary, conduit coupling assembly.

As illustrated, the unitary conduit coupling assembly is an integrated assembly which can comprise: (A) a first liquid tight connector having an internal diameter, with the first connector being configured for fitment to the jacketed conduit section. The coupling assembly further includes: (B) a second connector having an internal diameter, wherein the second connector comprises one of: (a) a rigid coupling; (b) an electrical metallic tubing (EMT) compression coupling; and (c) an electrical metallic tubing compression coupling including a compression nut.

For some applications, the present method includes providing the coupling assembly with: (C) a cylindrical adapter nipple having an internal diameter, wherein the adapter nipple has an external thread formation for threaded connection to each of the first and second connectors at the internal diameters thereof.

The present method is completed by respectively joining the first and second connectors of the conduit coupling assembly to the jacketed conduit, and to the associated conduit section to thereby connect the jacketed conduit to the conduit section. By this arrangement, associated wiring can be housed within the jacketed conduit section, the conduit section, and the conduit coupling assembly with the wiring extending though the internal diameters of each of the first and second connectors, and through the adapter nipple of the conduit coupling assembly if included in the coupling assembly.

In the preferred practice of the present method, an adhesive composition is applied to the external thread formation of the adapter nipple for securement of the adapter nipple to the first and second connectors of the conduit coupling assembly.

As will be appreciated, the present invention is very well-suited to a number of applications, including wiring transformers, solar systems, and pumps.

Other features and advantages of the present invention will be readily apparent from the following detailed description, accompanying drawings, and the appended claims.

### BRIEF DESCRIPTION OF THE DRAWINGS

FIG. 1 is a diagrammatic view of a conduit coupling assembly embodying the principles of the present invention;

FIG. 2 is a diagrammatic view of the present conduit coupling assembly shown in operative association with and fitment to a jacketed conduit and a conduit section, in accordance with the present invention;

FIG. 3 is a diagrammatic view of the components of the present conduit coupling assembly illustrating their arrangement and assembly;

FIG. 4 is a diagrammatic view of an alternative embodiment of a conduit coupling assembly embodying the principles of the present invention;

FIG. 5 is a diagrammatic view of the conduit coupling assembly of FIG. 4 shown in operative association with and fitment to a jacketed conduit and an associated conduit section, in accordance with the present invention;

FIG. 6 is a diagrammatic view of the components of the conduit coupling assembly shown in FIG. 4 illustrating their arrangement and assembly;

FIG. 7 is a diagrammatic view of a further alternative embodiment of a conduit coupling assembly embodying the principles of the present invention;

FIG. 8 is a diagrammatic view of the conduit coupling assembly of FIG. 7 shown in operative association with and fitment to a jacketed conduit and an associated conduit section, in accordance with the present invention; and

FIG. 9 is a diagrammatic view of the components of the conduit coupling assembly shown in FIG. 7 illustrating their arrangement and assembly.

### DETAILED DESCRIPTION OF THE INVENTION

While the present invention is susceptible to embodiment in various forms, there are shown in the drawings and will hereinafter be described presently preferred embodiments of the present invention, with the understanding that the present disclosure is to be considered as an exemplification of the invention, and is not intended to limit the invention to the specific embodiments illustrated herein.

Notably, features of the present invention have been recognized by those experienced in the industry as providing desirable cost-efficiency and reliability for assembly of differing conduit sections. In particular, at a recent trade show presented by the National Electrical Contractors Association (NECA), embodiments of the present invention were recognized, out of two hundred product submitted entries, as being one of twenty-five entries of particular merit, receiving the well-regarded “Show Stopper” Award, as recognized by a jury of industry experts.

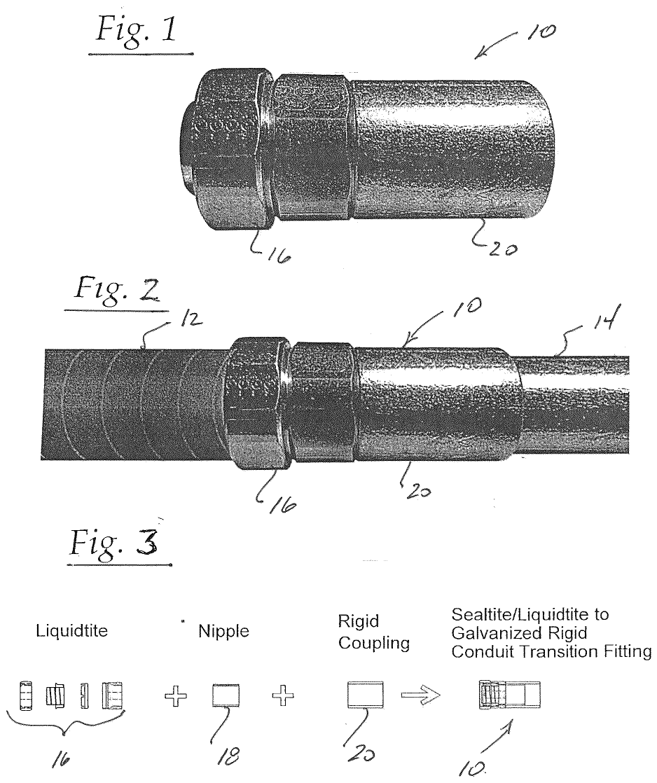

The present invention is directed to conduit coupling assembly, designated 10 in the embodiment of FIG. 1-3, which facilitates assembly of conduit sections, and associated tubular structures, with conduit components typically used in conjunction with electrical wiring. In the illustrated embodiments, the present coupling assembly facilitates assembly of the coupling assembly with an associated jacketed conduit 12 and an associated conduit section comprising a galvanized rigid conduit designated 14.

The coupling assembly 10 can be joined to the jacketed conduit 12 by the provision of a first liquid tight connector 16, and by the provision of a second connector 20 in the form of a rigid coupling configured for connection to galvanized rigid conduit 14 or another associated conduit section. First liquid tight connector 16, sometimes referred to as a “sealtite” connector, includes cooperating components, including an external compression nut, for forming a liquid tight connection to the jacketed conduit 12. As will be described, the second connector may be configured alternatively be configured as an electrical metallic tubing (EMT) compression coupling; or an electrical metallic tubing compression coupling including a compression nut.

In the illustrated embodiment, the present coupling assembly 10 further includes a cylindrical adapter nipple 18 having an internal diameter. The adapter nipple 18 has an external thread formation for threaded connection to each of the first and second connectors 16, 20 at internal diameters thereof. By this arrangement, associated wiring can be housed within the conduit coupling assembly 10, with the wiring extending though the internal diameters of each of the first and second connectors and the adapter nipple. Depending upon the specific configuration of the first and second connectors, the external thread formation of the adapter nipple can include two differing thread patterns for respective threaded connection to the first and second connectors of the coupling assembly.

For some applications, the conduit coupling assembly 10 can be configured without the provision of the adapter nipple 18. In such an arrangement, the liquid tight connector 16 is provided with an external or male thread formation for threaded engagement directly with an internal, female thread formation provided on the second connector 20. Application of a suitable adhesive to the mating thread formations is preferred.

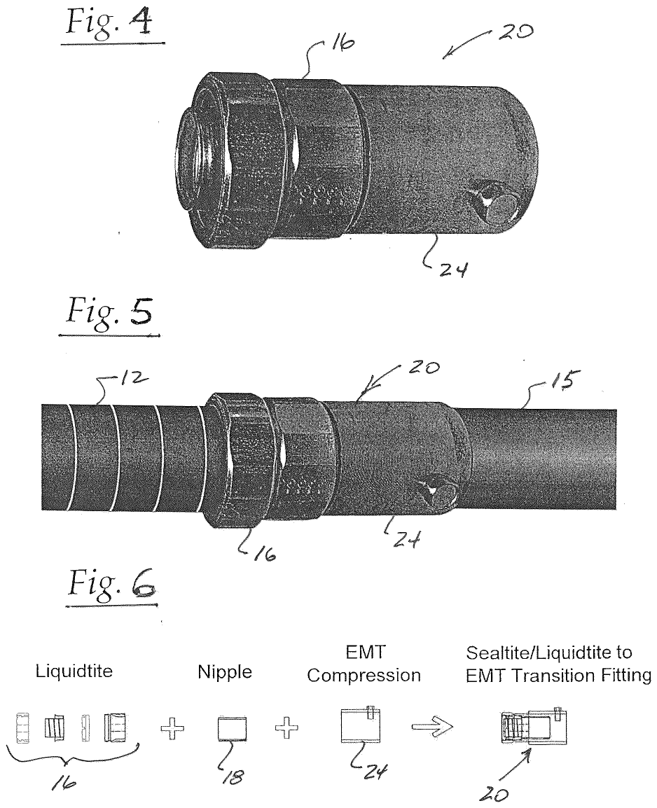

FIGS. 4-6 illustrate an alternative embodiment of the present conduit coupling assembly, designated 20. Like the previous embodiment, the coupling assembly 20 includes a first liquid tight connector 16 for fitment and securement to the associated jacketed conduit 12, and optionally an adapter nipple 18 having an external thread formation. In order to facilitate joining the jacketed conduit 12 to an associated conduit section, shown as EMT conduit section 15, the conduit coupling assembly 20 includes a second connector 24 in the form of an EMT compression fitting.

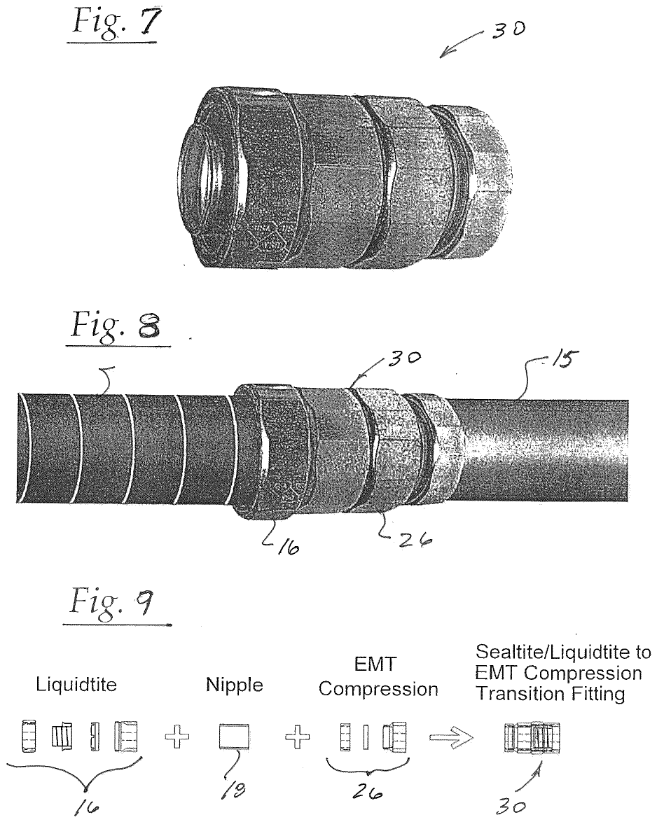

FIGS. 7-9 illustrate a further alternative embodiment of the present conduit coupling assembly, designated 30. As in previous embodiments, the coupling assembly 30 includes a first liquid tight connector 16 for fitment and securement to the associated jacketed conduit 12, and optionally an externally threaded adapter nipple 18. To facilitate joining the jacketed conduit 12 to an associated conduit section, shown as EMT conduit, coupling assembly 30 includes a second connector in the form of EMT compression fitting 26 including a compression nut.

In accordance with the present invention, a method of connecting a jacketed conduit to an associated conduit section comprises the steps of providing the jacketed conduit, and the conduit section. The present method further entails providing a unitary conduit coupling assembly comprising an integrated assembly of its components.

As illustrated, the conduit coupling assembly comprises: (A) a first liquid tight connector having an internal diameter, the first connector being configured for threaded fitment to the jacketed conduit section. The coupling assembly further includes: (B) a second connector having an internal diameter, therein the second connector comprises one of: (a) a rigid coupling; (b) an electrical metallic tubing (EMT) compression coupling; and (c) an electrical metallic tubing compression coupling. The coupling assembly further includes: (C) a cylindrical adapter nipple having an internal diameter, wherein the adapter nipple has an external thread formation for threaded connection to each of the first and second connectors at the internal diameters thereof.

The present method is completed by respectively joining the first and second connectors of the conduit coupling assembly to the jacketed conduit, and to the conduit section to thereby connect the jacketed conduit to the conduit section. By this arrangement, associated wiring can be housed within the jacketed conduit section, the conduit section, and the conduit coupling assembly with the wiring extending though the internal diameters of each of the first and second connectors and the adapter nipple of the conduit coupling assembly.

From the foregoing, it will be observed that numerous modifications and variations of the present invention can be effected without departing from the spirit and scope of the novel concept present invention. It is to be understood that no limitation with respect to the specific embodiments illustrated herein is intended or should be inferred. The disclosure is intended to cover, by the appended claims, all such modifications that fall within the scope of the claims.

1. A conduit coupling assembly, comprising:
a first liquid tight connector having an internal diameter, said first connector being configured for fitment to associated jacketed conduit; and
a second connector having an internal diameter, said second connector comprising one of: (a) a rigid coupling; (b) an electrical metallic tubing (EMT) compression coupling; and (c) an electrical metallic tubing compression coupling including a compression nut, and being joined to said liquid tight connector,
whereby said conduit coupling assembly can be assembled with associated conduit sections, so that associated wiring can be housed within the conduit coupling assembly.

2. A conduit assembly in accordance with claim 1, including
a cylindrical adapter nipple having an internal diameter, said adapter nipple having an external thread formation for threaded connection to each of said first and second connectors at said internal diameters thereof, whereby associated wiring can be housed within the conduit coupling assembly by with said wiring extending though the internal diameters of each of said first and second connectors and said adapter nipple.

3. A conduit assembly in accordance with claim 1, wherein
said liquid tight connector defines and external thread formation, and said second connector defines and internal thread formation for threaded engagement with said external thread formation of said liquid tight connector.

4. A conduit coupling assembly in accordance with claim 1, including
an adhesive composition applied to said liquid tight connector and to said second connector.

5. A conduit coupling assembly in accordance with claim 2, including
an adhesive composition applied to the external thread formation of said adapter nipple for securement of said adapter nipple to said first and second connectors.

6. A method of connecting a jacketed conduit to an associated conduit section, comprising the steps of:
providing said jacketed conduit, and said associated conduit section;
providing a conduit coupling assembly, said conduit coupling assembly comprising: (A) a first liquid tight connector having an internal diameter, said first connector being configured for fitment to said jacketed conduit section, (B) a second connector having an internal diameter, said second connector comprising one of: (a) a rigid coupling; (b) an electrical metallic tubing (EMT) compression coupling; and (c) an electrical metallic tubing compression coupling including a compression nut;
respectively joining said first and second connectors to said jacketed conduit and to said conduit section to connect said jacketed conduit to said conduit section, whereby associated wiring can be housed within the jacketed conduit section, said conduit section, and said conduit coupling assembly by with said wiring extending though the internal diameters of each of said first and second connectors and said adapter nipple.

7. A method of connection in accordance with claim 6, including:
providing said conduit coupling assembly including: (C) a cylindrical adapter nipple having an internal diameter, said adapter nipple having an external thread formation for threaded connection to each of said first and second connectors at said internal diameters thereof.

8. A method of connection in accordance with claim 7, including:
Applying an adhesive composition to the external thread formation of said adapter nipple for securement of said adapter nipple to said first and second connectors.

9. A method in accordance with claim 6, including
providing an external thread formation on said liquid tight connector (B) for threaded engagement with an internal thread formation provided on said second connector (C) of said conduit coupling assembly.

10. A method of connection in accordance with claim 9, including
an adhesive composition applied to said liquid tight connector and to said second connector.
